(19) United States
(12) Patent Application Publication
(10) Pub. No.: US 2024/0269949 A1
(43) Pub. Date: Aug. 15, 2024

(54) Multipurpose wind turbine blade manufacturing vessel with onboard storage and testing facilities

(71) Applicant: Samuel Messinger, Ramot Bet Shemish (IL)

(72) Inventor: Samuel Messinger, Ramot Bet Shemish (IL)

(21) Appl. No.: 18/108,667

(22) Filed: Feb. 13, 2023

(51) Int. Cl. B29D 99/00

(52) U.S. Cl. CPC B29D 99/0028

(57) ABSTRACT

The present invention relates to a multipurpose wind turbine blade manufacturing vessel, comprising of a hull with a bow and a stern, along with a propulsion arrangement. The vessel is equipped with a manufacturing, storage and a testing facility to manufacture and safely stow the different parts of the manufactured turbine blades until required for installation. The different manufacturing stages are all located in the hull with multiple blades stow-away spaces available under as well as a over a partially covered hull.

### FIELD OF INVENTION

The present invention relates to the design of a mobile wind turbine blade manufacturing vessel with onboard storage capabilities.

### BACKGROUND AND SUMMARY OF THE INVENTION

Renewable energy offers a sustainable and clean alternative to fossil fuels, which are a major contributor to climate change and air pollution. Renewable energy sources, such as wind, solar, and hydro power, do not produce emissions or pollutants, and they have the potential to significantly reduce our reliance on fossil fuels. The global renewable energy market can be characterized into wind, solar, hydro, geothermal, and biomass. Driven by factors such as declining costs for renewable energy technologies, favorable government policies, and increasing concerns about climate change, this market has grown rapidly in recent years, with the sector contributing 26% of the world's entire electricity demand in 2019, and projections of up to 30% of global power production from renewable resources by 2030.

According to the Global Wind Energy Council (GWEC), the global installed wind power capacity had reached 729 GW by the end of 2020, a 14% increase from the previous year. China, the US, and Europe are the largest markets for wind energy, with China alone accounting for more than one-third of the global installed wind power capacity. Wind power capacity relies heavily on the wind speed in the locations where the wind turbines are installed. Typically, offshore installation of wind farms in relatively shallow waters near coastlines, offer higher wind speeds as compared to onshore installations, making offshore wind farms a desirable green power generation network.

A typical wind farm comprises of multiple wind turbines installed at heights above the water level. An offshore wind turbine may have a height ranging from 35 m to 116 m, with turbine blade spans of up to 164 m, making the wind turbine blade design and manufacturing a highly challenging task. The increasing heights, and wider wing spans result from mathematical equations which indicate a four-fold increase in wind turbine output every time the propeller length is doubled.

The manufacturing of a wind turbine blade starts with the CAD design to optimize the blade shape and structure for optimum efficiency, structural integrity, and adequate aerodynamics. Careful selection of manufacturing materials for the blade is done for the system to function efficiently, followed by a mold creation process. Based on the CAD design, related molds are created to layer the selected materials to be cast into the desired shapes. The cured blades are finished by polishing and inspecting for any visible/invisible defects before being transported onto the installation location.

The most widely used method to manufacture long wind turbine blades is the resin infusion technology. In this method, the shell halves are typically manufactured separately through individual blade molds. As a first step, a blade gel coat is applied on the mold, followed by the placement of a fiber/fabric reinforcement layer. The final step is to fill the cavity between the fibers with resin, before curing the resulting structure with heat. Resin transfer molding (RTM) and vacuum resin transfer molding (VARTM) are two of the most widely used techniques in this domain. EP2796709A1, US20190070801A1, US20200398459A1, and US20220152964A1 disclose some of the RTM-based wind turbine blade manufacturing techniques. A flexible mold is disclosed in US20220143875A1 so that the mold may be folded for storage or transportation purposes. Regardless of the actual nature of the mold, design of the RTM-based large wind turbine propeller blades requires preparation of molds followed by resin infusion. In most cases, the rotor blades are designed in two aeroshells with a load carrying box, or internal shears which bond the aeroshells together.

EP3874157A1, JP430261B2 and EP2466122B1 disclose methods of fabricating the individual rotor blades as separate halves. Using multiple techniques, the halves may be joined to form the finished blade. The actual process of molding and joining the individual halves depends on the design of the blade and the amount of flexibility and strength required by the blade design.

Once completed, the blades are then transported onto the installation location where large cranes propel the blades to their position and installation on the rotor axis. Considering the sheer size of the blades, transportation from the manufacturing/storage facility to the installation location is a time intensive process, often requiring closure of public roads and traffic stoppages. Offshore installations pose additional difficulties of hiring transport and lifting vessels to deliver and install the blades on marine windfarms.

One of the main challenges in wind farm installation is the transportation of the finished wind turbine blades from the manufacturing facility to the installation location. Due to the sheer scale of the blades, spanning more than 100 m in length in some cases, the added weight, fragility and high sensitivity to environmental factors, transportation of the turbine blades is a cumbersome process requiring accuracy and significant financial investment which in some cases may surpass USD 100,000. Special trucks and vessels are required to carry the long propeller blades to remote locations requiring closure of public roads, transportation during nonpeak hours, and even police escorts throughout the transportation process. EP2796709A1 and U.S. 9,429,139B2 disclose arrangements to safely stack finished turbine blades for transportation either on land or on a vessel. The arrangement is colossal in size, and the size of the truck/vessel required for transportation varies depending on the actual size of the blades. With offshore installations, the challenges increase exponentially; requiring hiring of multiple vessels to transport and erect the blades while on water adding significantly into the logistical costs of the setup.

Considering the challenges involved in offshore transportation of wind turbine blades, it is therefore highly desirable to construct or retrofit a vessel to manufacture the propeller blades on site. In case where the maritime solution is not applicable/feasible, docking the specially bult vessel to the nearest location may also be the best solution. Traditional modes of road transport may be used to transport the finished blades to the land-based winf farm site at much lesser costs.

A novel design of a vessel is proposed herein allowing manufacture, testing, and limited storage capabilities for the manufactured wind turbine blades on-site until installation. The presented design of the vessel provides fully operational molding, polishing, testing and finishing stages for wind turbine blade manufacturing onboard the vessel. Moreover, storage of the manufactured blades on deck is also provided. The goal of this invention is to cut the costs of having separate manufacturing as well as logistical arrangements for offshore wind turbine blade manufacturing and transportation. The single vessel design proposed herein allows for on-site manufacturing, eliminating the logistical costs and providing an efficient manufacturing-on-site model.

The invention will now be explained in further detail in light of the embodiments as explained in the accompanying drawings.

### BRIEF DESCRIPTION OF THE DRAWINGS

A more precise appreciation of the disclosure and many of the attendant advantages thereof will be readily obtained as the same becomes better understood by reference to the following detailed description when considered in connection with the accompanying drawings, wherein:

FIG. 1 shows a typical horizontal axis wind turbine (HAWT).

FIG. 2 depicts the longitudinal as wells as cross-sectional view of a typical wind turbine blade.

FIG. 3 shows the different parts of a finished wind turbine blade.

FIG. 4 shows the side view of the preferred embodiment of the present invention.

FIG. 5 shows the top view of the preferred embodiment of the present invention.

FIG. 6 shows a molding station as disclosed in the prior-art.

FIG. 7 shows a wind turbine blade clamping apparatus as disclosed in the prior-art.

FIG. 8 shows a typical wind turbine blade transportation arrangement on a flat-bed trailer.

FIG. 9 shows a typical wind turbine blade transportation arrangement on a dedicated cargo vessel.

Similar reference characters denote corresponding features consistently throughout the attached drawings.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents, as well as equivalents developed in the future (i.e., any elements developed that perform the same function, regard less of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided using dedicated hardware as well as hardware capable of executing associated software. Those of ordinary skill in the art further understand that the exemplary hardware, software, processes, methods, and/or operating systems described herein are for illustrative purposes only and, thus, are not intended to be limited to any particular named manufacturer.

The terminology used herein is for the purpose of describing specific embodiments only and is not intended to be limiting of all possible embodiments. As used herein, the singular forms “a”, “an”, and “the” are intended to include the plural forms as well, unless the context indicates otherwise. It will be further understood that the terms “comprises”, “comprising”, “constitutes”, “constituting”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

The actual vessels to manufacture wind turbine propellers need to be retrofitted to accommodate the specialized machinery required to manufacture each propeller. In one embodiment a new design of a vessel is presented. In another embodiment conversion of a VLCC 330-meter (1082) vessel into the desired manufacturing facility is disclosed. In another embodiment conversion of a ULCC 415-meter (1361 feet) vessel to the proposed configurations is presented. In yet another embodiment conversion of a cargo ship into the proposed configuration is disclosed.

In each embodiment the complete equipment and machinery used to fabricate these propellers on land customized to accommodate boat movement and the available physical space is disclosed. The vessel will have facilities for a dedicated crew to work shifts day and night 24 hours a day 7 days a week (estimated 60 employees). The vessel will also have the raw materials needed to make the propellers such as epoxy, resin, fiberglass cloth, carbon material etc. There will be a testing station to test a propeller like land testing. Also, it is possible that a smaller supply vessel will accompany the larger manufacturing vessel. Also nearby may be a warehouse vessel holding finished propellers for installation.

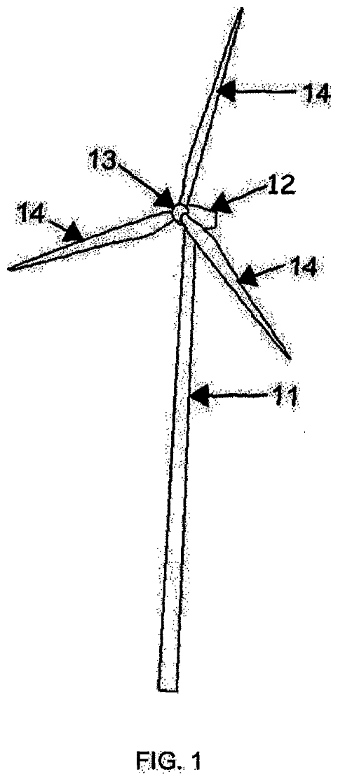

FIG. 1 shows a conventional horizontal axis wind turbine (HAWT) also referred to as an upward wind turbine. The setup consists of a mast 11 with a nacelle 12 housing the energy generators/turbines connected to a rotor with horizontal rotor shaft. The rotor comprises of a rotor hub 13 and a plurality of rotor blades 14 connected to the rotor shaft centrally at the rotor hub 13.

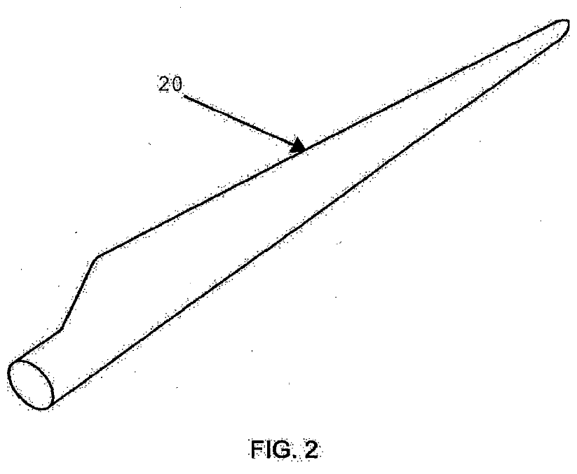

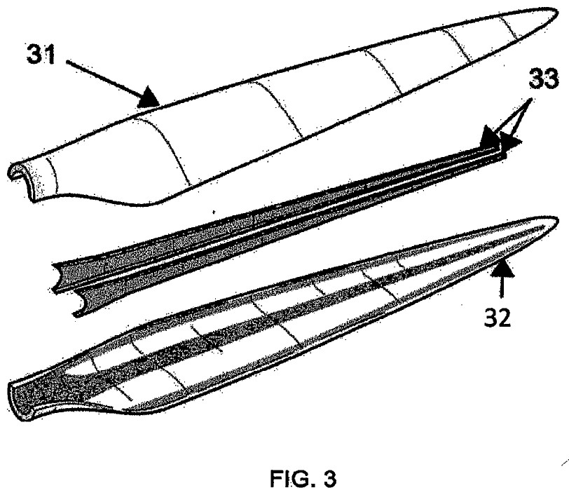

FIG. 2 represents a longitudinal view of a conventional wind turbine blade 20. As shown in FIG. 3, a wind turbine blade consists of two faces 31 and 32, joined together and stiffened by one or multiple integral shears 33 linking and joining the two faces together.

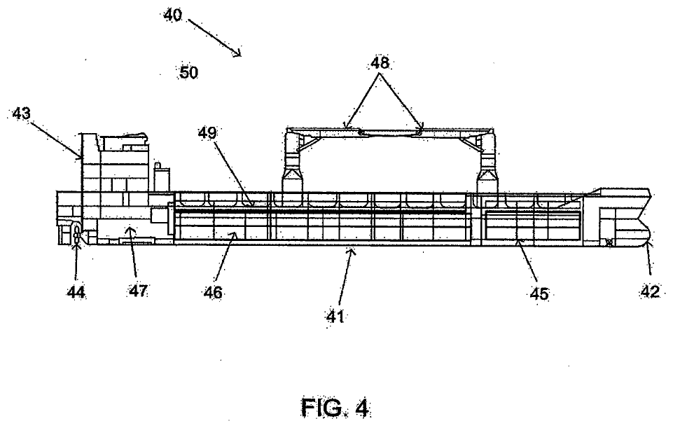

FIG. 4 shows the exemplary embodiment of the invention with a side view of the proposed wind turbine blade manufacturing vessel 40. The same principle would apply to retrofitted vessels (VLCC-330, ULCC-415 and the like) or any converted cargo ships. The vessel 40 comprises of a hull 41, a bow 42, and a stern 43. The propulsion system 44 is powered by a suitable engine with the ability to propel the entire vessel as desired. The turbine blade manufacturing setup as proposed in this embodiment of the present invention comprises of subdividing the hull 41 into two sub-manufacturing areas: the material preparation station 45 and the high pressure molding station 46. Based on the CAD specifications and the consumer requirement, the resin is prepared at the preparation station 45, which is then injected into multiple prefabricated molds placed in a parallel configuration (cross-sectionally) at the molding station 46. The necessary temperature and high pressure required for the mold injection and subsequent formation is achieved using the setup installed in the machine room 47. Once the blade surfaces have been molded and assembled into finished blades, cranes 48 lift the finished blades out of the molding station 46 and into the testing station 49 where the different structural properties of the finished blades are tested to ensure compliance to specifications/regulations. Once tested, the finished blades may be lifted out of the testing station 49 onto the deck 50 where they are stacked till required for installation.

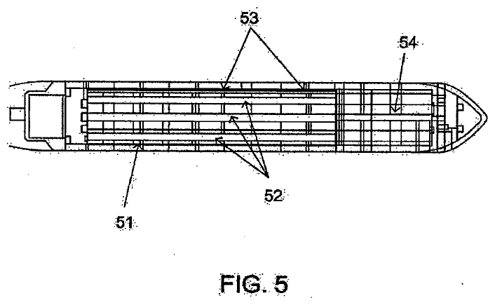

FIG. 5 shows a top view of the preferred embodiment of the disclosed wind turbine manufacturing vessel. A mechanized opening 51 is provided on the hull 41 located directly above the testing station 49. Multiple molding and finishing stations 52 produce finished blades, which are then lifted by the cranes 53 and brought onto the testing station 49 as shown in FIG. 4. The tested blades may then be placed above the deck such that multiple finished bladed may be lifted from the testing station 49 through the mechanized opening 51 and stacked above deck. A resin storage space 54 is provided on deck where the raw material for the injection process may be stored before processing.

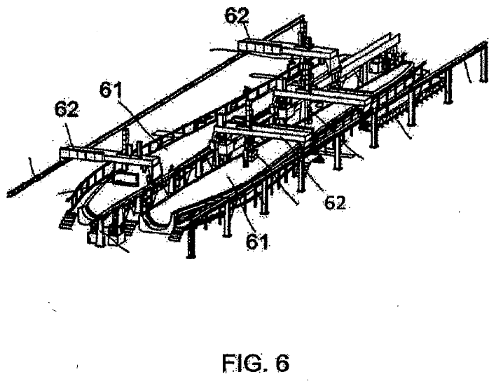

FIG. 6 shows an embodiment of the molding station as described in the prior-art. The molding station comprises of two molds 61, corresponding to the two halves of the propeller blade, placed parallel to each other along the width of the hull running across the length towards the stern. A series of overhead, movable spray nozzles 62 are installed such that the nozzles can be moved across the length of the mold 61. Specially formulated resins may be sprayed on the mold before joining the two halves together.

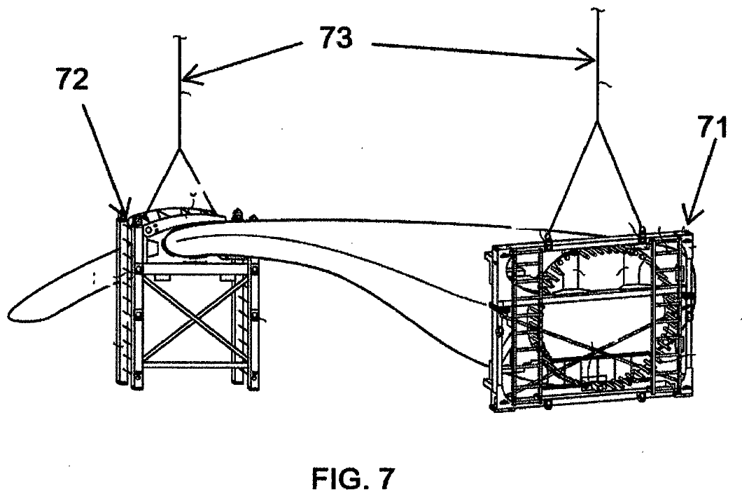

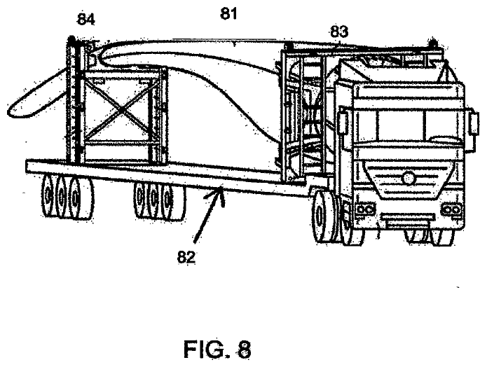

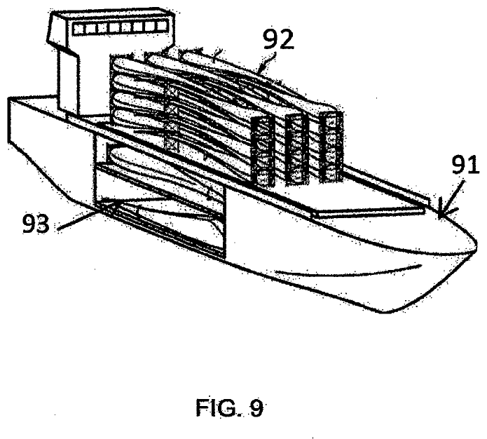

FIG. 7 shows a typical holding arrangement for the finished wind turbine blades as disclosed in the prior-art. The setup comprises of a root clamp 71 and a tip clamp 72 holding the root and tip of the finished wind turbine blade respectively. Optionally, two holding cables 73 may be used to lift/lower the blade as desired. FIG. 8 shows an exemplary embodiment utilizing the holding setup of FIG. 7 for transporting a wind turbine blade 81 using a flat-bed trailer 82. The length of the trailer bed 82 depends entirely on the length of the wind turbine blade forming the payload, with the root and tip clamps 83 and 84 dictating the length of the trailer-bed required for safe transportation. Similarly, a stacked storage arrangement on a vessel in shown in FIG. 9. Multiple blades 92 are stacked on the deck on the vessel 91 using the holding arrangement of FIG. 7. Additionally, in case of a transportation vessel, multiple finished blades may also be stored inside the hull 93.

It must be understood that although large vessels have been used for transporting finished wind turbine blades, this invention proposes a complete manufacturing facility on the vessel. By utilizing/retrofitting a significantly large vessel with the different stations required for wind turbine blade manufacturing and testing, the vessel would form a detailed mobile manufacturing as well as limited storage facility on water. The disclosed invention would provide on-site manufacturing of wind turbine blades for offshore or coastal wind farm installations. Moreover, for on-land wind farms, the proposed vessel may dock at a nearby location and the finished blades may be transported via traditional flat-bed trailers to the location. This would hep save significant logistical expenses.

Furthermore, It is to be understood that the present invention is not limited to the embodiments described above but encompasses any and all embodiments within the scope of the following claims.

I claim:

1. A wind turbine blade manufacturing vessel comprising essentially of;
a resin manufacturing station;
a molding and finishing station;
a finished blade testing station;
a finished blade lifting setup; and a stackable finished blade storage.

2. The wind turbine blade manufacturing vessel of claim 1 wherein,
The resin manufacturing station is located within the hull of the vessel and contains the necessary equipment to develop the resins required to create the blade through vacuum molding.

3. The wind turbine blade manufacturing vessel of claim 1 wherein,
The hull of the vessel contains, the molding and finishing station comprising of a plurality of identical vacuum molding and finishing stations with prefabricated molds of the desired wind turbine bladed design are installed in a parallel arrangement along the width of the hull; the testing station comprising of a plurality of identical test benches located one level above the molding and the finishing station to check for any defects in the finished wind turbine blades; and
a mechanized opening on deck corresponding directly above the testing station.

4. The wind turbine blade manufacturing vessel of claim 1. wherein,
a plurality of cranes installed on deck with the ability to lift the finished wind turbine blades from inside the molding and finishing station in the hull to the testing station level located directly above; and
a plurality of cranes installed on deck with the ability to lift the tested wind turbine blades from inside the testing station in the hull to the and placing them in a stacked arrangement on deck.

5. A method to manufacture wind turbine blades on the vessel comprising;
Preparing a desired resin mixture as required for the wind turbine blade;
injecting the prepared resin into the plurality of prefabricated molds in the molding and finishing station of the vessel;
maintaining the required temperature and pressure in the molding and finishing station;
assembling the multiple molded sides of the wind turbine blade into a finished blade;
lifting the finished bladed out of the molding and finishing station and into the testing station;
lifting the tested blade out of the testing station and placing on deck for storage until installation; and
lifting the stored finished wind turbine blades from the deck and projecting them onto the nacelle at the installation cite offshore.

6. The multipurpose wind turbine blade manufacturing vessel of claim 1, further comprising a resin storage space on the deck for storing raw materials, such as resin, epoxy, and other necessary materials, before the manufacturing process.

7. The multipurpose wind turbine blade manufacturing vessel of claim 1, wherein the onboard storage facilities on the deck allow for stacking finished blades until they are ready for installation, reducing logistical costs and improving efficiency.

8. The multipurpose wind turbine blade manufacturing vessel of claim 1, further comprising a supply vessel accompanying the manufacturing vessel for transportation of materials, equipment, or personnel.
